(19) United States
(12) Patent Application Publication
(10) Pub. No.: US 2009/0094798 A1
(43) Pub. Date: Apr. 16, 2009

(54) LOW PROFILE CORD LOCK

(75) Inventor: Nieh-Cheng Yao, Chungli City (TW)

Correspondence Address: NIFCO TAIWAN CORPORATION, P.O.BOX 108-00403, TAIPEI, 106, TW

(73) Assignee: NIFCO TAIWAN CORPORATION, Taipei (TW)

(21) Appl. No.: 11/870,409

(22) Filed: Oct. 10, 2007

(51) Int. Cl. F16G 11/04

(52) U.S. Cl. 24/115 G

(57) ABSTRACT

A low profile cord lock includes a female cord lock member, which has two insertion holes at two sides of an accommodation chamber thereof and two locating grooves in the insertion holes at the bottom side, a male cord lock member, which is received in the accommodation chamber and has a through hole and two protruding blocks that are respectively inserted into the insertion holes of the female cord lock member to allow vertical movement of the male cord lock member relative to the female cord lock member between a first position where the through hole is in axial alignment with the insertion holes for the insertion of a cord member and a second position where the through hole is deviated from the insertion holes and the inserted cord member is clocked, and a spring member mounted supported between the female cord lock member and the male cord lock member to hold male cord lock member in the second position.

### BACKGROUND OF THE INVENTION

1. Field of the Invention

The present invention relates to cord locks and more particularly, to a low profile cord lock, which comprises a low profile female cord lock member, a male cord lock member received in the female cord lock member and vertically movable relative to the female cord lock member between an upper limit position for the insertion of a cord member through the female cord lock member and the male cord lock member and a lower limit position to jam the inserted cord member, and a spring member connected between the female cord lock member and the male cord lock member to support the male cord lock member in the upper limit position.

2. Description of the Related Art

Many fasteners have been disclosed for use in shoes, bags or clothes. A cord lock is a fastener for locking a cord member. When a cord lock is unlocked, it can be moved along the inserted cord member to adjust the opening of the shoe, bag or clothe in which the cord member is installed.

FIG. 8 illustrates a cord lock according to the prior art. According to this design, the cord lock comprises a button A, a socket B and a spring member C. The button A is a stepped cylinder having a shank A1, a through hole A2 transversely cut through the shank A1, two protruding blocks A3 protruded from the periphery at two opposite sides and abutted against the bottom side of the through hole A2, and an extension rod A4 axially extending from the distal end of the shank A1. The protruding blocks A3 each have a flat top side and an arched bottom side. The socket B comprises a cylindrical body shell B1, an open chamber B2 defined in the cylindrical body shell B1, two through holes B5 cut through the periphery of the cylindrical body shell B1 and disposed in communication with the open chamber B2 at two sides, a locating rod B3 upwardly extending from the bottom wall of the cylindrical body shell B1 and suspending in the open chamber B2, and two guide blocks B4 inwardly protruded from the inside wall of the cylindrical body shell B1 and respectively disposed above the through holes B5. The spring member C is received in the open chamber B2 and coupled between the locating rod B3 and the extension rod A4. When inserting the button A into the open chamber B2, the protruding blocks A3 will be moved along the guide blocks B4 to the inside of the open chamber B2. When a user presses the button A to compress the spring member C, the through hole A2 of the button A is moved into axial alignment with the through holes B5 of the socket B for the insertion of a cord member. When the user releases the hand from the button A, the spring member C immediately pushes the button A upwards to lock the cord member. This structure of cord lock is still not satisfactory in function. Because the cord lock and the inserted cord member extend in a crossed manner, the cylindrical cord lock cannot be kept closely attached to the surface of the shoe, bag or clothe carrying the cord member, destructing the sense of beauty of the article. Further, the user may feel uncomfortable when pressed the cord lock accidentally. In case the cord member is disconnected from the through hole A2 of the button A and the through holes B5 of the socket B accidentally, the parts of the cord lock may escape from one another. In this case, the user shall have to spend a lot of time to assemble the parts again. According to this design, the spring member C is a coil spring. When pressing the button A to compress the spring member C, the spring member C may be curved, causing vibration or tilting of the button A. Further, this design of cord lock has a certain height, not suitable for low profile application.

Another design of cord lock, as shown in FIG. 9, is comprised of a female cord lock member D and a male cord lock member E. The male cord lock member E is received in a receiving open chamber D2 of the female cord lock member D with spring strips E21 in front and rear elastic support members E2 stopped against the smoothly curved inside wall of the receiving open chamber D2 of the female cord lock member D and two opposite end protrusions E11 respectively stopped at the top side of a passage hole D1 of the female cord lock member D. When pressed an embossed top press portion E3 of the male cord lock member E, the male cord lock member E is moved along two opposite vertical inside walls D22 of the female cord lock member D to deform the spring strips E21 and to force the end protrusions E11 into a locating groove D11 in the passage hole D1. At this time, a passage hole E1 of the male cord lock member E is incorporated into the passage hole D1 of the female cord lock member D for the insertion of a cord member. When the user releases the hand from the embossed press portion E3, the spring strips E21 immediately return to their former shape to return the male cord lock member E, thereby locking the inserted cord member. According to this design, the spring strips E21 in the front and rear elastic support members E2 of the male cord lock member E are integrally injection-molded from plastics and the bottom ends of the spring strips E21 are kept at the same elevation. The mold design requires a high precision. If the spring strips E21 do not have an equal length, the male cord lock member E will vibrate or be tilted when it is pressed, causing alignment between of the passage holes D1 and E1 difficult. Further, when an excessively high pressure is applied to the male cord lock member E against the female cord lock member D, a concentration of stress may occur, causing the spring strips E21 to crack or to break. Further, the design of the spring strips E21 is suitable only for a low safety level application that requires low clamping force.

Therefore, it is desirable to provide a cord lock that eliminates the drawbacks of the aforesaid prior art designs.

### SUMMARY OF THE INVENTION

The present invention has been accomplished under the circumstances in view. It is one object of the present invention to provide a cord lock, which has a low profile.

To achieve this and other objects of the present invention, the cord lock comprises a female cord lock member, the female cord lock member comprising an accommodation chamber extending to a top side thereof, two insertion holes respectively disposed in communication with the accommodation chamber at two opposite sides and axially aligned in line, two locating grooves respectively disposed in the insertion holes at a bottom side, and a transverse slot cut through a lower part thereof below the accommodation chamber and extending in direction perpendicular to the extending direction of the insertion holes; a belt member inserted through the transverse slot of the female cord lock member for fastening the female cord lock member to an external object; a male cord lock member received in the accommodation chamber of the female cord lock member and vertically movable relative to the female cord lock member, the male cord lock member comprising a through hole cut through two opposite sides thereof, and two protruding blocks respectively protruded from the two opposite sides and respectively inserted into the insertion holes of the female cord lock member to secure the male cord lock member to the female cord lock member and to allow vertical movement of the male cord lock member relative to the female cord lock member between a first position where the through hole of the male cord lock member is in axial alignment with the insertion holes of the female cord lock member and a second position where the through hole of the male cord lock member is deviated from the insertion holes of the female cord lock member; and a spring member mounted in the accommodation chamber and stopped between the female cord lock member and the male cord lock member to support the male cord lock member in the second position.

### BRIEF DESCRIPTION OF THE DRAWINGS

FIG. 1 is an elevational view of a low profile cord lock according to the present invention.

FIG. 2 is an exploded view of the low profile cord lock according to the present invention.

FIG. 3 is an exploded view in section of the low profile cord lock according to the present invention.

FIG. 4 is a sectional side view of the present invention, showing the low profile cord lock assembled.

FIG. 5 is a schematic sectional view of the present invention, showing the through hole of the male cord lock member disposed in axial alignment with the insertion holes of the female cord lock member and a cord member inserted through the through hole of the male cord lock member and the insertion holes of the female cord lock member.

FIG. 6 is similar to FIG. 5 but showing the cord member locked.

FIG. 7 is an elevational view showing an application example of the present invention.

FIG. 8 is an exploded view of a cord lock according to the prior art.

FIG. 9 is an exploded view of a cord lock according to another prior art design.

### DETAILED DESCRIPTION OF THE PREFERRED EMBODIMENT

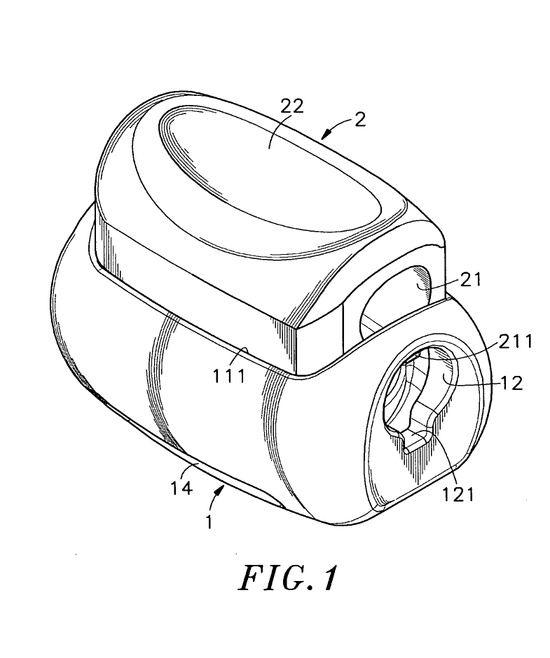

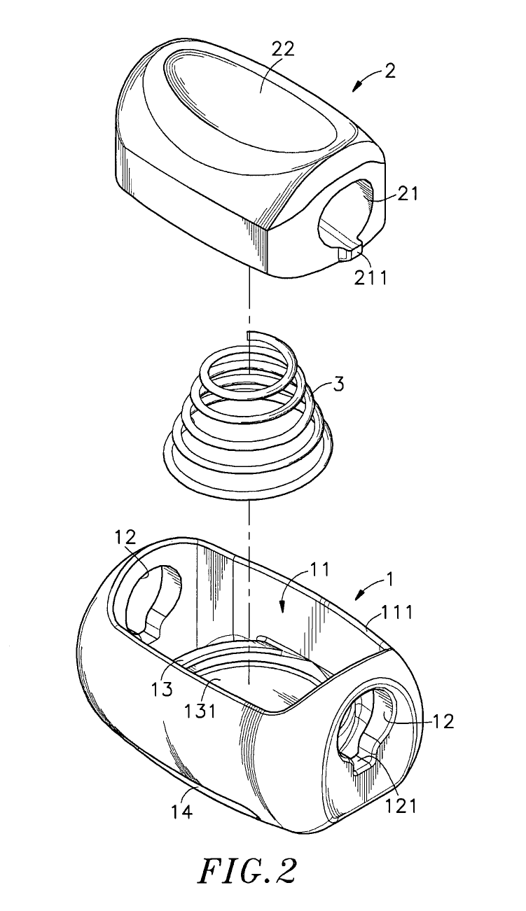

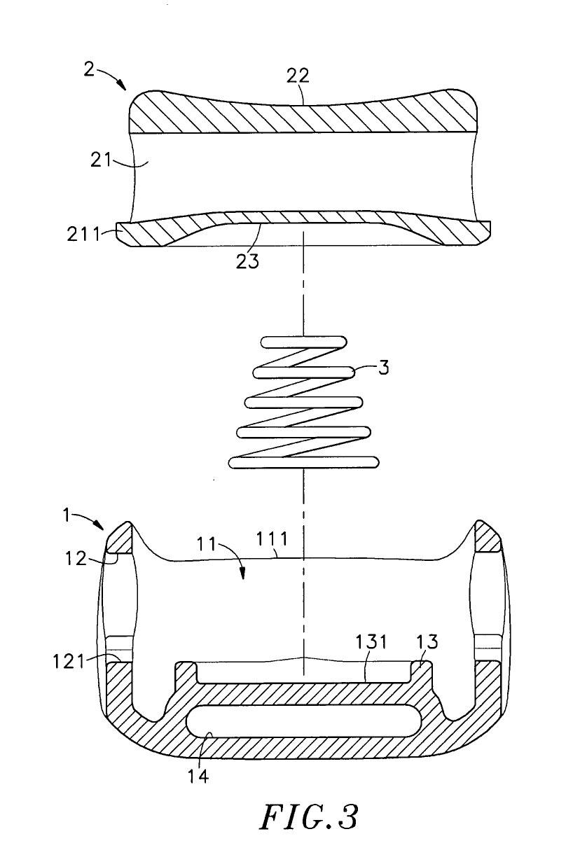

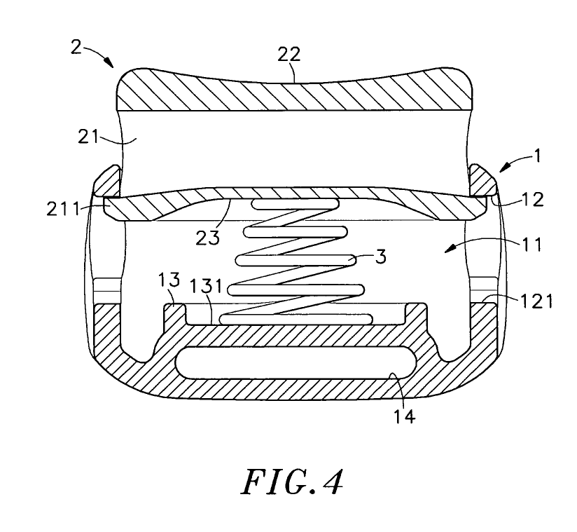

Referring to FIGS. 1-4, a low profile cord lock in accordance with the present invention is shown comprising a female cord lock member 1, a male cord lock member 2 and a spring member 3.

The female cord lock member 1 is a hollow container having an accommodation chamber 11 adapted to accommodate the male cord lock member 2 and the spring member 3, a top opening 111 at the top side of the accommodation chamber 11, two insertion holes 12 respectively cut through two first opposite sides thereof and aligned in line in X-axis direction at two opposite sides of the accommodation chamber 11, two locating grooves 121 respectively disposed in the insertion holes 12 at a bottom side, a bearing seat 13 protruded from the bottom wall of the accommodation chamber 11 and defining a positioning recess 131 inside the accommodation chamber 11, and a transverse slot 14 cut through two second opposite sides thereof and extending in Y-axis direction.

The male cord lock member 2 has a through hole 21 cut through two opposite sides thereof corresponding to the extending direction of the insertion holes 12 of the female cord lock member 1, two protruding blocks 211 respectively protruded from the two opposite sides in reversed directions and disposed at a bottom side relative to the two distal ends of the through hole 21 for positioning in the locating grooves 121 of the female cord lock member 1, a press portion 22 at the top side of the through hole 21, and a bearing portion 23 at the bottom side of the through hole 21 opposite to the press portion 22. The bearing portion 23 is formed of a part of the bottom wall of the male cord lock member 2 and curved inwards toward the inside of the male cord lock member 2.

The spring member 3 is set in between the female cord lock member 1 and the male cord lock member 2. The spring member 3 can be a spring plate, helical spring or conical spring compressible in vertical direction. According to the present preferred embodiment, the spring member 3 is a conical spring for the advantage of small size, high bearing capacity, characteristic of variation in rigidity and low profile after compressed. The spring member 3 has its relatively greater bottom end fastened to the positioning recess 131 of the bearing seat 13 of the female cord lock member 1 and its relatively smaller top end stopped against the bottom surface of the bearing portion 23 of the male cord lock member 2.

During installation, the bottom end of the spring member 3 is positioned in the positioning recess 131 of the bearing seat 13 of the female cord lock member 1, and then the male cord lock member 2 is inserted through the top opening 111 of the female cord lock member 1 into the accommodation chamber 11 to have the protruding blocks 211 be inserted into the insertion holes 12 of the female cord lock member 1 respectively. Thus, the male cord lock member 2 is vertically movable in the accommodation chamber 11 relative to the female cord lock member 1. Because the protruding blocks 211 are respectively inserted into the insertion holes 12 of the female cord lock member 1, the male cord lock member 2 is vertically movable relative to the female cord lock member 1 within a limited range between an upper limit position where the protruding blocks 211 are respectively stopped at the top side of each insertion hole 12 of the female cord lock member 1 and a lower limit position where the protruding blocks 211 are respectively engaged into the locating grooves 121 in the insertion holes 12 of the female cord lock member 1, and will not escape out of the accommodation chamber 11 of the female cord lock member 1.

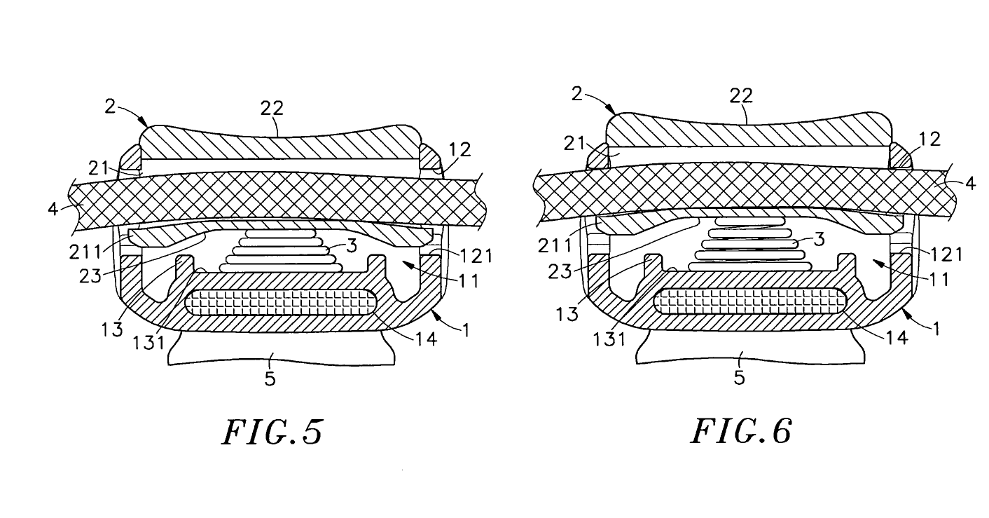

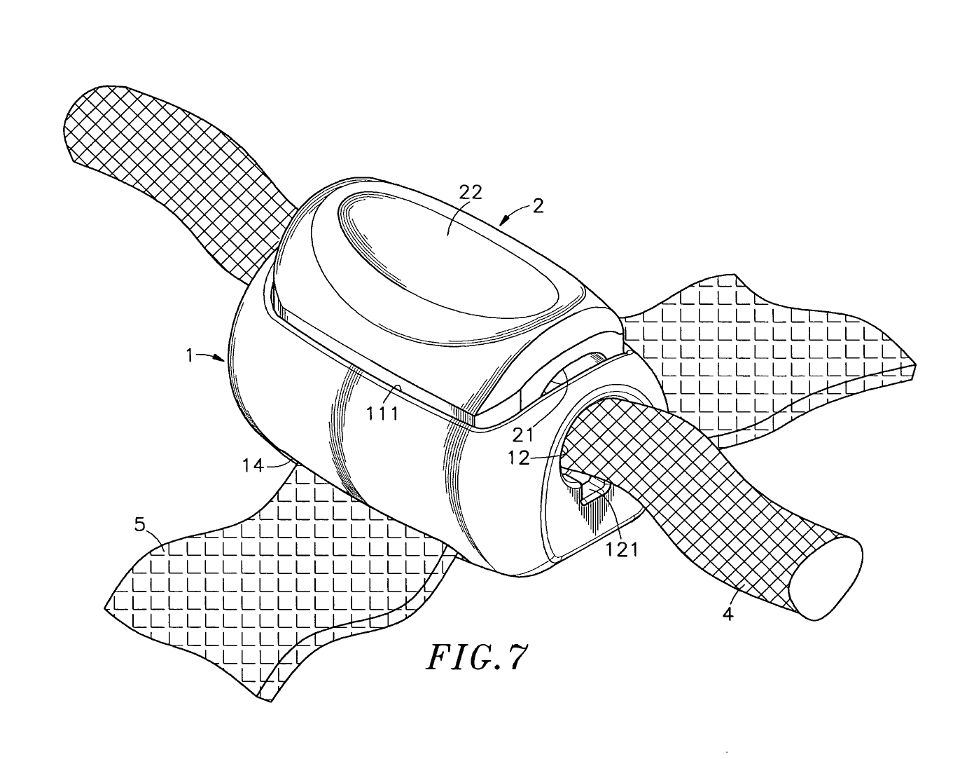

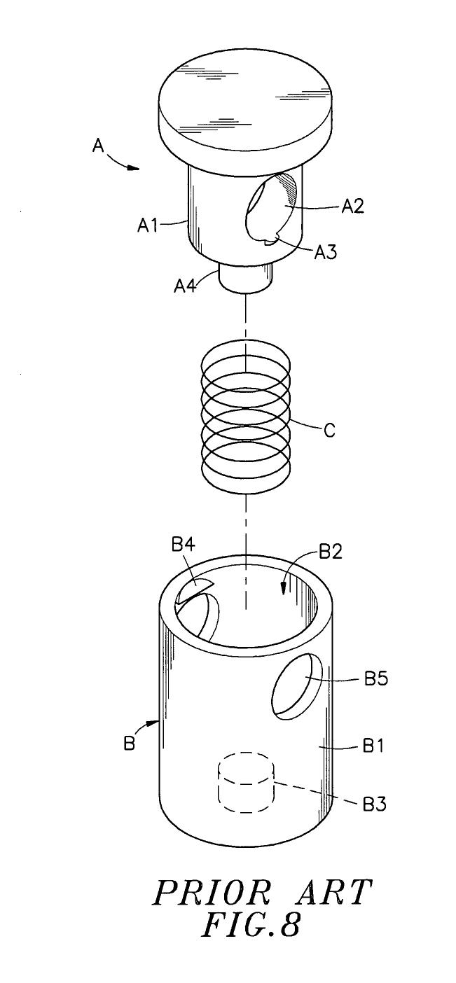

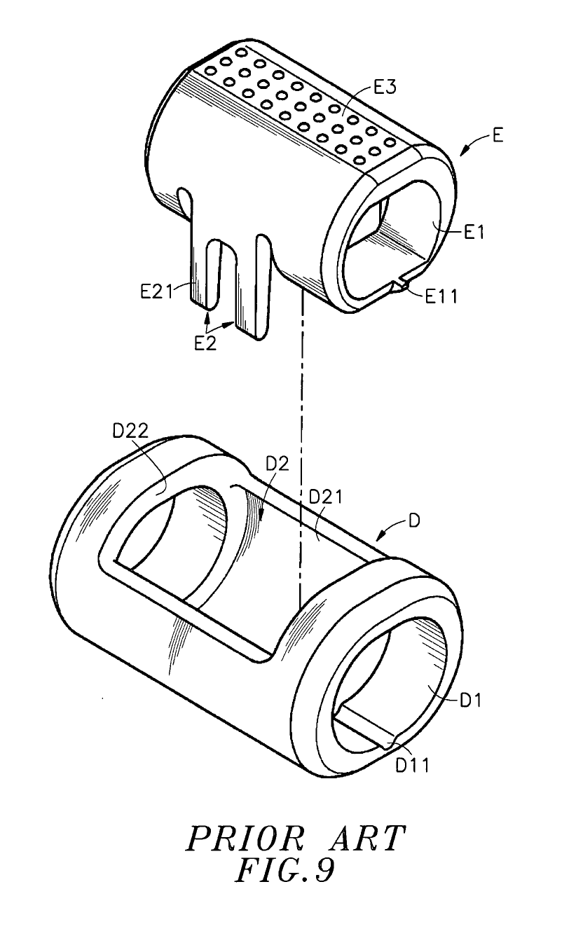

Referring to FIGS. 5-7, a belt member (fabric strap, binding belt, elastic band, Velcro tape, etc.) 5 is inserted through the transverse slot 14 of the female cord lock member 1 to fasten the female cord lock member 1 to an object (shoe, bag, garment, etc.). Thereafter, a user can press the press portion 22 to lower the male cord lock member 2 in the accommodation chamber 11 of the female cord lock member 1 against the spring member 3 and to force the protruding blocks 211 into the locating grooves 121. At this time, the through hole 21 of the male cord lock member 2 is kept in axial alignment with the insertion holes 12 of the female cord lock member 1 for the insertion of a cord member 4. When the user releases the hand from the press portion 22 of the male cord lock member 2 after insertion of the cord member 4 through the insertion holes 12 of the female cord lock member 1 and the through hole 21 of the male cord lock member 2, the spring member 3 immediately pushes the male cord lock member 2 upwards to the upper limit position where the through hole 21 of the male cord lock member 2 is deviated from the insertion holes 12 of the female cord lock member 1, and therefore the cord member 4 is jammed in between the male cord lock member 2 and the female cord lock member 1.

As stated above, the invention provides a cord lock, which has the following features and benefits:

1. When the user presses the male cord lock member 2 against the female cord lock member 1, the insertion holes 12 and the through hole 21 are axially aligned to unlock the cord member 4, allowing movement of the cord member 4 relative to the male cord lock member 2 and the female cord lock member 1. On the contrary, when the user releases the hand from the male cord lock member 2, the spring member 3 immediately returns the male cord lock member 2, causing the cord member 4 to be jammed in between the male cord lock member 2 and the female cord lock member 1, i.e., the cord member 4 is locked at this time.

2. The transverse slot 14 of the female cord lock member 1 extends in direction perpendicular to the extending direction of the insertion holes 12 for the insertion of a belt member 5 to fasten the female cord lock member 1 to a shoe, bag or garment.

3. The spring member 3 is positioned in the positioning recess 131 of the bearing seat 13 of the female cord lock member 1 and stopped against the bearing portion 23 of the male cord lock member 2 to support vertical movement of the male cord lock member 2 relative to the female cord lock member 1 stably. The spring member 3 is selected from a conical spring for the advantages of small size, high bearing capacity, characteristic of variation in rigidity and low profile after compressed.

4. The insertion holes 12 and the through hole 21 respectively cut through the female cord lock member 1 and the male cord lock member 2 horizontally in X-axis direction for the insertion of the cord member 4 in horizontal direction. Therefore, the female cord lock member 1 can be made having a height just slightly greater than the diameter of the cord member 4, i.e., the cord lock can be made having a low profile.

5. The spring member 3 is firmly positioned in the positioning recess 131 of the bearing seat 13 of the female cord lock member 1 to support the male cord lock member 2. When the user presses the press portion 22 to lower the male cord lock member 2, the spring member 3 is vertically compressed to prevent vibration or tilting of the male cord lock member 2. When a high pressure is applied to the press portion 22, the locating grooves 121 limit the down stroke of the protruding blocks 211, preventing damage to the spring member 3.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A cord lock comprising:
a female cord lock member, said female cord lock member comprising an accommodation chamber extending to a top side thereof, two insertion holes respectively disposed in communication with said accommodation chamber at two opposite sides and axially aligned in line, and two locating grooves respectively disposed in said insertion holes at a bottom side;
a male cord lock member received in said accommodation chamber of said female cord lock member and vertically movable relative to said female cord lock member, said male cord lock member comprising a through hole cut through two opposite sides thereof, and two protruding blocks respectively protruded from the two opposite sides and respectively inserted into said insertion holes of said female cord lock member to secure said male cord lock member to said female cord lock member and to allow vertical movement of said male cord lock member relative to said female cord lock member between a first position where said through hole of said male cord lock member is in axial alignment with said insertion holes of said female cord lock member and a second position where said through hole of said male cord lock member is deviated from said insertion holes of said female cord lock member; and
a spring member mounted in said accommodation chamber and stopped between said female cord lock member and said male cord lock member to support said male cord lock member in said second position.

2. The cord lock as claimed in claim 1, wherein said female cord lock member comprises a bearing seat disposed inside said accommodation chamber and adapted to hold one end of said spring member.

3. The cord lock as claimed in claim 2, wherein said female cord lock member has a transverse slot extending across a bottom side of said bearing seat in direction perpendicular to the extending direction of said insertion holes for the mounting of a belt member.

4. The cord lock as claimed in claim 1, wherein said male cord lock member has a bottom bearing portion smoothly curved inwards at a bottom side thereof and stopped against one end of said spring member, and a top press portion disposed at a top side thereof opposite to said bottom bearing portion.

5. The cord lock as claimed in claim 1, wherein said spring member is a helical spring.

6. The cord lock as claimed in claim 1, wherein said spring member is a conical spring.

7. A cord lock comprising:
a female cord lock member, said female cord lock member comprising an accommodation chamber extending to a top side thereof, two insertion holes respectively disposed in communication with said accommodation chamber at two opposite sides and axially aligned in line, two locating grooves respectively disposed in said insertion holes at a bottom side, and a transverse slot cut through a lower part thereof below said accommodation chamber and extending in direction perpendicular to the extending direction of said insertion holes;
a belt member inserted through said transverse slot of said female cord lock member for fastening said female cord lock member to an external object;
a male cord lock member received in said accommodation chamber of said female cord lock member and vertically movable relative to said female cord lock member, said male cord lock member comprising a through hole cut through two opposite sides thereof, and two protruding blocks respectively protruded from the two opposite sides and respectively inserted into said insertion holes of said female cord lock member to secure said male cord lock member to said female cord lock member and to allow vertical movement of said male cord lock member relative to said female cord lock member between a first position where said through hole of said male cord lock member is in axial alignment with said insertion holes of said female cord lock member and a second position where said through hole of said male cord lock member is deviated from said insertion holes of said female cord lock member; and
a spring member mounted in said accommodation chamber and stopped between said female cord lock member and said male cord lock member to support said male cord lock member in said second position.

8. The cord lock as claimed in claim 7, wherein said female cord lock member comprises a bearing seat disposed inside said accommodation chamber and adapted to hold one end of said spring member.

9. The cord lock as claimed in claim 7, wherein said male cord lock member has a bottom bearing portion smoothly curved inwards at a bottom side thereof and stopped against one end of said spring member, and a top press portion disposed at a top side thereof opposite to said bottom bearing portion.

10. The cord lock as claimed in claim 7, wherein said belt member is an elastic band.

11. The cord lock as claimed in claim 7, wherein said belt member is a Velcro tape.

12. The cord lock as claimed in claim 7, wherein said belt member is a binding belt.

13. The cord lock as claimed in claim 7, wherein said belt member is an elastic band.

14. The cord lock as claimed in claim 7, wherein said spring member is a compression spring.

15. The cord lock as claimed in claim 7, wherein said spring member is a plate spring.
